(19) United States
(12) Patent Application Publication
(10) Pub. No.: US 2008/0039035 A1
(43) Pub. Date: Feb. 14, 2008

(54) Antenna based listen-before-talk apparatus, system and method

(76) Inventor: Joshua Posamentier, Oakland, CA (US)

Correspondence Address: INTEL CORPORATION;c/o INTELLEVATE, LLC, P.O. BOX 52050, MINNEAPOLIS, MN, 55402, US

(21) Appl. No.: 11/503,429

(22) Filed: Aug. 10, 2006

(51) Int. Cl. H04B 1/18

(52) U.S. Cl. 455/185.1

(57) ABSTRACT

An embodiment of the present invention provides an apparatus, comprising an antenna capable of taking listen-before-talk (LBT) measurements. The antenna may further comprise an active peak/envelope detector, a comparator, and a bias-tee for extracting DC off of a coaxial feed feeding the antenna. In an embodiment of the present invention, the apparatus may further comprise a radio transceiver including a current source, a bias tee, and a current sense circuit for detecting behavior of the antenna.

### BACKGROUND

LBT stands for Listen-Before-Talk. Radio frequency identification tags (RFID) or other sensor tags (although the present invention is not limited to RFID or other sensor tags) may require that a reader determine that no other device is using a frequency channel before transmitting. LBT may provide this information. A reader, for example, may establish a listen mode and a talk mode to implement this directive. During the listen mode, the reader determines whether a device is operating on the channel. The talk mode (transmitter on) begins when the reader has determined a channel is available.

Currently, LBT measurements are taken at the radio receiver rather than at the antenna. This is more difficult (up to 6 dB of additional sensitivity may be required to make up for loss between the antenna element and the receiver) and takes much longer (multiplexing Rx to each antenna rather than simultaneously monitoring all ports).

Thus, a strong need exists for an antenna based listen-before-talk apparatus, system and method.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 provides an illustration of an apparatus using an antenna based LBT of one embodiment of the present invention; and

FIG. 2 illustrates a method of operation of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, RF identification tags and systems, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN), wireless metropolitan area networks (WMAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

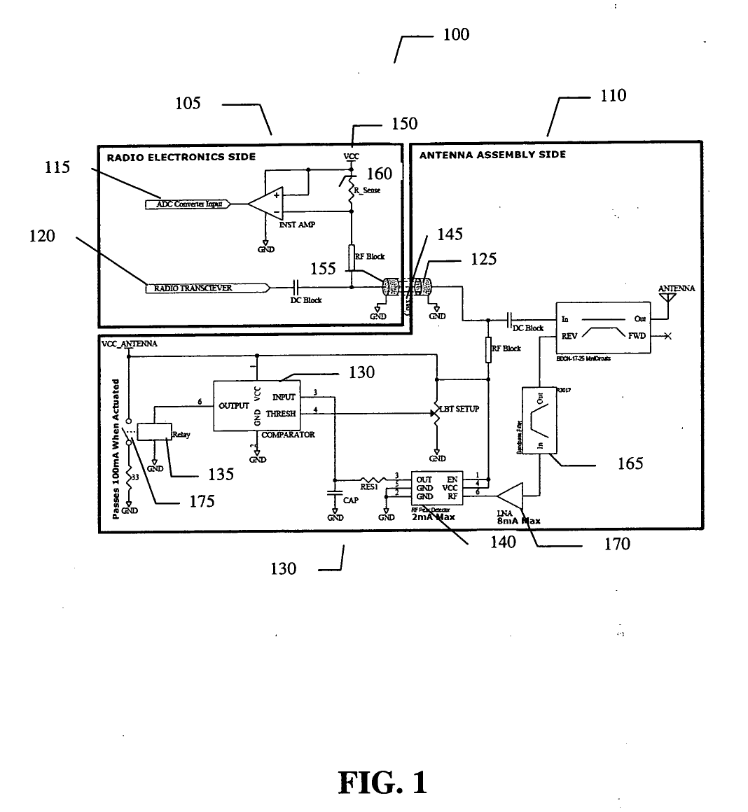

An embodiment of the present invention provides simplification and performance improvements relative to the listen-before-talk (LBT) requirements that may be required in, for example, RFID methods, apparatus and systems such as, but not limited to, those inherent in the ETSI 302-208 RFID band specification. As depicted in FIG. 1, shown generally as 100, this system may consist of both an antenna assembly 110 with an active envelope detector 140, a comparator 130, and a bias-tee 125 for extracting DC off of the coaxial feed 145. The radio electronics side 105 may include a radio transceiver 120, an ADC converter 115 which is input to a current sense circuit 160 for detecting behavior of the antenna subsystem 110. The radio transceiver 120, current source 150 and bias tee 155 are included as shown in the radio electronics side 105.

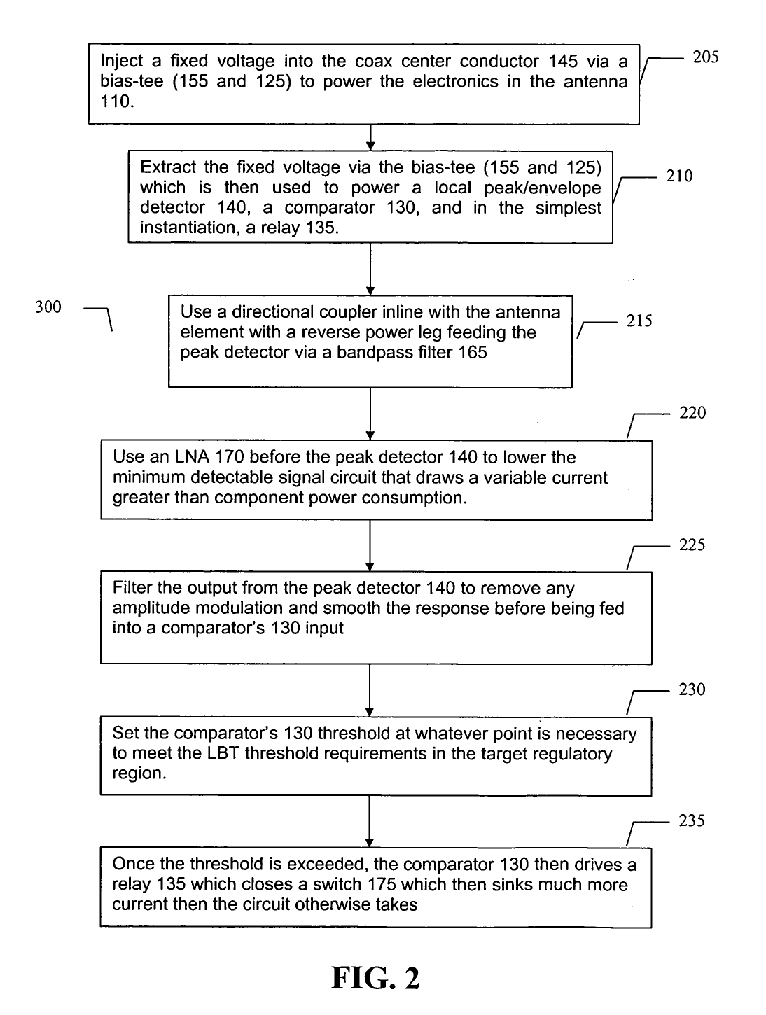

Turning now to FIG. 2, generally at 200, is a method of an embodiment of the present invention, which provides at 205 injecting a fixed voltage into the coax center conductor 145 via a bias-tee (155 and 125) to power the electronics in the antenna 110. The antenna subsystem 110 may include a bias tee 125 for extracting 210 the fixed voltage which is then used to power a local peak/envelope detector 140, a comparator 130, and in the simplest instantiation, a relay 135. There may also be a directional coupler inline with the antenna element with the reverse power leg feeding 215 the peak detector via a bandpass filter 165. As is shown in this circuit diagram, an LNA 170 may be added 220 before the peak detector 140 to lower the minimum detectable signal. The output from this peak detector 140 may be filtered 225 to remove any amplitude modulation and smooth the response before being fed into a comparator's 130 input. This comparator's 130 threshold is set 230 at whatever point is necessary to meet the LBT threshold requirements in the target regulatory region. Once the threshold is exceeded, the comparator 130 then drives 235 a relay 135 which closes a switch 175 which then sinks much more current then the circuit otherwise takes. This results in a distinct increase in current draw over the coax line 145 which the current sense circuit 160 in the radio subsystem 105 can easily detect, thus comprehending an ambient signal level at the antenna 110 which then (by the regulations) restricts transmission activity.

Although not limited in this respect, in an embodiment of the present invention in a system of multiple antennas (typically 4+), a system like this can provide significant time savings in terms of constantly monitoring all antennas simultaneously rather than having to multiplex between them. It may also reduce the burden to the LBT circuit in terms of sensitivity because it eliminates the loss of the cabling between the receiver and the radio by placing the high sensitivity components at the antenna.

In another embodiment of the present invention and not limited in this respect, the relay may be replaced with a FET circuit that draws a variable current greater than the component power consumption, that the radio side current sense can interpret as an actual signal level seen by the antenna for variable LBT purposes.

Yet another embodiment of the present invention provides a machine-accessible medium that provides instructions, which when accessed, cause a machine to perform operations comprising taking listen-before-talk (LBT) measurements in an antenna. The machine-accessible medium may further comprise the instructions causing the machine to perform operations further comprising using an active peak/envelope detector, a comparator and a bias-tee that extracts DC voltage off of a coaxial feed feeding the antenna to take the LBT measurements and may further comprise the instructions causing the machine to perform operations further comprising detecting behavior of the antenna by using a radio transceiver including a current source, a bias tee, and a current sense circuit.

Still another embodiment of the present invention may provide a system, comprising an antenna capable of taking listen-before-talk (LBT) measurements and a radio transceiver including a current source, a bias tee, and a current sense circuit for detecting behavior of the antenna. The antenna of this system may further comprise an active peak/envelope detector, a comparator and a bias-tee for extracting DC off of a coaxial feed feeding the antenna.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. An apparatus, comprising:
an antenna adapted to take listen-before-talk (LBT) measurements.

2. The apparatus of claim 1, wherein said antenna further comprises:
an active peak/envelope detector;
a comparator; and
a bias-tee for extracting DC off of a coaxial feed feeding said antenna.

3. The apparatus of claim 2, further comprising:
a radio transceiver including a current source, a bias tee, and a current sense circuit for detecting behavior of said antenna.

4. The apparatus of claim 3, wherein said apparatus injects a fixed voltage into a coax center conductor via a bias-tee to power electronics in said antenna.

5. The apparatus of claim 4, wherein said antenna's bias tee extracts said fixed voltage which is then used to power said active peak/envelope detector, said comparator, and a relay.

6. The apparatus of claim 4, wherein said antenna's bias tee extracts said fixed voltage which is then used to power said active peak/envelope detector, said comparator, and an FET circuit that draws a variable current greater than component power consumption.

7. The apparatus of claim 5, further comprising a directional coupler inline with an antenna element with a reverse power leg feeding a peak detector via a bandpass filter.

8. The apparatus of claim 7, further comprising a low noise amplifier (LNA) placed before the peak detector to lower the minimum detectable signal and wherein the output from said peak detector is filtered to remove any amplitude modulation and smooth the response before being fed into a comparator's input.

9. The apparatus of claim 8, wherein said comparator's threshold is set at whatever point is necessary to meet an LBT threshold requirement in a target regulatory region and once said threshold is exceeded, said comparator then drives said relay which closes a switch which then sinks sufficient current that results in a distinct increase in current draw over said coax line which a current sense circuit in said transceiver can detect, thus comprehending an ambient signal level at the antenna which then restricts transmission activity.

10. A method, comprising:
taking listen-before-talk (LBT) measurements in an antenna.

11. The method of claim 10, further comprising using an active peak/envelope detector, a comparator and a bias-tee that extracts DC voltage off of a coaxial feed feeding said antenna to take said LBT measurements.

12. The method of claim 11, further comprising:
detecting behavior of said antenna by using a radio transceiver including a current source, a bias tee, and a current sense circuit.

13. The method of claim 12, further comprising injecting a fixed voltage into a coax center conductor via a bias-tee to power electronics in said antenna.

14. The method of claim 13, further comprising extracting said fixed voltage by said antenna's bias tee which is then used to power said active peak/envelope detector, said comparator, and a relay.

15. The method of claim 13, further comprising extracting said fixed voltage by antenna's bias tee which is then used to power said active peak/envelope detector, said comparator, and an FET circuit that draws a variable current greater than component power consumption.

16. The method of claim 14, further comprising using a directional coupler inline with an antenna element with a reverse power leg feeding a peak detector via a bandpass filter.

17. The method of claim 16, further comprising placing a low noise amplifier (LNA) before the peak detector to lower the minimum detectable signal and filtering the output from said peak detector to remove any amplitude modulation and smooth the response before being fed into a comparator's input.

18. The method of claim 17, further comprising setting said comparator's threshold at whatever point is necessary to meet an LBT threshold requirement in a target regulatory region and once said threshold is exceeded, said comparator then drives said relay which closes a switch which then sinks sufficient current that results in a distinct increase in current draw over said coax line which a current sense circuit in said transceiver can detect, thus comprehending an ambient signal level at the antenna which then restricts transmission activity.

19. A machine-accessible medium that provides instructions, which when accessed, cause a machine to perform operations comprising:
taking listen-before-talk (LBT) measurements in an antenna.

20. The machine-accessible medium of claim 19, further comprising said instructions causing said machine to perform operations further comprising using an active peak/envelope detector, a comparator and a bias-tee that extracts DC voltage off of a coaxial feed feeding said antenna to take said LBT measurements.

21. The machine-accessible medium of claim 20, further comprising said instructions causing said machine to perform operations further comprising detecting behavior of said antenna by using a radio transceiver including a current source, a bias tee, and a current sense circuit.

22. The machine-accessible medium of claim 21, further comprising said instructions causing said machine to perform operations further comprising injecting a fixed voltage into a coax center conductor via a bias-tee to power electronics in said antenna.

23. The machine-accessible medium of claim 22, further comprising said instructions causing said machine to perform operations further comprising extracting said fixed voltage by said antenna's bias tee which is then used to power said active peak/envelope detector, said comparator, and a relay.

24. The machine-accessible medium of claim 22, further comprising said instructions causing said machine to perform operations further comprising extracting said fixed voltage by antenna's bias tee which is then used to power said active peak/envelope detector, said comparator, and an FET circuit that draws a variable current greater than component power consumption.

25. The machine-accessible medium of claim 23, further comprising said instructions causing said machine to perform operations further comprising using a directional coupler inline with an antenna element with a reverse power leg feeding a peak detector via a bandpass filter.

26. The machine-accessible medium of claim 25, further comprising said instructions causing said machine to perform operations further comprising placing a low noise amplifier (LNA) before the peak detector to lower the minimum detectable signal and filtering the output from said peak detector to remove any amplitude modulation and smooth the response before being fed into a comparator's input.

27. The machine-accessible medium of claim 26, further comprising said instructions causing said machine to perform operations further comprising setting said comparator's threshold at whatever point is necessary to meet an LBT threshold requirement in a target regulatory region and once said threshold is exceeded, said comparator then drives said relay which closes a switch which then sinks sufficient current that results in a distinct increase in current draw over said coax line which a current sense circuit in said transceiver can detect, thus comprehending an ambient signal level at the antenna which then restricts transmission activity.

28. A system, comprising:
an antenna capable of taking listen-before-talk (LBT) measurements; and
a radio transceiver including a current source, a bias tee, and a current sense circuit for detecting behavior of said antenna.

29. The system of claim 28, wherein said antenna further comprises:
an active peak/envelope detector;
a comparator; and
a bias-tee for extracting DC off of a coaxial feed feeding said antenna.

30. The system of claim 29, wherein said apparatus injects a fixed voltage into a coax center conductor via a bias-tee to power electronics in said antenna.

31. The system of claim 30, wherein said antenna's bias tee extracts said fixed voltage which is then used to power said active peak/envelope detector, said comparator, and a relay and.

32. The system of claim 30, wherein said antenna's bias tee extracts said fixed voltage which is then used to power said active peak/envelope detector, said comparator, and an FET circuit that draws a variable current greater than component power consumption.

33. The system of claim 31, further comprising a directional coupler inline with an antenna element with a reverse power leg feeding a peak detector via a bandpass filter and a low noise amplifier (LNA) placed before the peak detector to lower the minimum detectable signal and wherein the output from said peak detector is filtered to remove any amplitude modulation and smooth the response before being fed into a comparator's input.

34. The system of claim 33, wherein said comparator's threshold is set at whatever point is necessary to meet an LBT threshold requirement in a target regulatory region and once said threshold is exceeded, said comparator then drives said relay which closes a switch which then sinks sufficient current that results in a distinct increase in current draw over said coax line which a current sense circuit in said transceiver can detect, thus comprehending an ambient signal level at the antenna which then restricts transmission activity.
